(19) United States
(12) Patent Application Publication
(10) Pub. No.: US 2013/0266698 A1
(43) Pub. Date: Oct. 10, 2013

(54) FROZEN SOLID STATE HEAT RELIEVING THIRST QUENCHER

(71) Applicants: Nigel Bruce OLDHAM, Taichung City (TW); Chen-chi Wang, Taichung City (TW)

(72) Inventors: Nigel Bruce OLDHAM, Taichung City (TW); Chen-chi Wang, Taichung City (TW)

(21) Appl. No.: 13/440,130

(22) Filed: Apr. 5, 2012

(51) Int. Cl. A23L 2/02; A23L 1/305; A23L 1/30; A23L 1/304

(52) U.S. Cl. 426/112; 426/599

(57) ABSTRACT

The present invention relates to a frozen solid state heat relieving thirst quencher, mainly configured to comprise a container or bag of soft or hard materials for convenient hand-carry applications. The container is filled with the heat relieving thirst quencher which can be presented in its solid state through a freezing process, thereby allowing convenient portability and readiness to serve anytime by direct consumption so as to achieve the heat relieving and thirst quenching effects such as stamina supplementation, electrolyte replenishment and body temperature reduction and the like. Meanwhile, in case of sport injuries or insect stings, it can be used for ice covering and swelling subsiding purposes. When the internal heat relieving thirst quencher is totally molten, it can be frozen once again to return to its solid state thus enabling practical usage advantages for various objectives and convenient portability.

### BACKGROUND OF THE INVENTION

1. Field of the Invention

The present invention relates to a frozen solid state heat relieving thirst quencher, essentially retaining the heat relieving thirst quencher in a frozen and solid state thereby allowing easy storage and portability. Accordingly, when performing outdoor sports or activities, the user can consume the heat relieving thirst quencher for expected functions like body energy supplementation and thirst relieving, and, since the heat relieving thirst quencher features its frozen solid state allowing ice covering effect, it can be also refrozen again to return to its solid state after melting, thereby achieving the advantage of excellent product utilization in practical applications.

2. Description of Related Art

It is common that people become soaked with sweat when performing outdoor sports or activities like jogging, ball playing, bicycling, mountain climbing, to name a few. Along with effusion of perspirations from skin, water and salt in human body are also exuded, causing body temperature elevation and reductions in physical functions. Hence, timely supplementations of water, electrolytes and the like are definitely necessary, otherwise dehydration, sunstroke or other physical discomfort symptoms may occur.

In general, for water and electrolyte supplementations after or during sportive activities, people may directly drink water or beverages, e.g., sport drinks, to resolve this issue. With various ingredients contained in the sport drinks, it is possible to supplement exuded water and enable thirst quenching and heat relieving effects, as well as provide many elementary nutrients like electrolytes, amino acids, sugar, salt etc., thereby restoring stamina and physical functions and eliminating tiredness. Regarding to currently available sport drinks in market, there can be roughly categorized into two types: the bottled or canned sport drink in liquid form and the condensed sport drink pellets in powder form. The former is most favorable for general consumers due to characteristics in easy open and direct drinking The latter, on the other hand, also becomes popular for its convenience in portability.

However, in terms of bottled sport drinks, although it provides the open-to-drink advantage, significant volume and weight do cause inconvenience in use. To enable cooling and refreshing effects, it is required to prepare ice cubes or to use a refrigerator to freeze them in advance, which may be complicated and tedious. Additionally, the volume thereof usually reaches more than 300˜600 cc, so in case that a bottle of sport drink is not completely consumed, the remained portion may lead to troubles in storage and hand-carry. Or some users simply directly throw away the remained sport drink or pour on their heads for heat relieving, and such littering may result in unnecessary wastage and environment pollution.

Meanwhile, the other type of sport drinks is the condensed sport drink pellets in powder form. Although it provides advantage in portability, it is required to apply conjunctively potable water for preparation to allow a user to drink, so convenience thereof may be reduced in use. Besides, it needs to follow a certain powder-to-water ratio during preparation because excessive or insufficient water addition may both influence the effect, which is also useless for resolving the wastage issue. Similarly, to achieve the cooling and refreshing effects, additional ice cubes are also required, thus making this approach not really ideal.

Furthermore, with regards to the aforementioned liquid sport drinks or condensed sport drink pellets in powder form, they both mainly resort to heat relieving and thirst quenching by supplementations of electrolytes, amino acids, sugar, salt and water, and so forth. Except inconveniences and problems in hand-carry, preparation and consumption processes, in case of sport injuries or inset stings, they are not able to timely provide emergent nursing functions, e.g., ice covering, as the present invention.

### SUMMARY OF THE INVENTION

In view of the drawback that currently available liquid sport drinks and powdered sport drink pellets both can only provide heat relieving and thirst quenching effects, the inventors of the present application devoted efforts in researches for solutions thereto and worked out a frozen solid state heat relieving thirst quencher of the present invention which essentially aims to, by means of its structural combination design, offer a product enabling heat relieving and thirst quenching functions and also further allows this frozen state sports drinks can be used as a bag of frozen peas giving cold treatment when there are acute injuries occur. The patent we seek is for the commercial provision of sports drinks formulate as in the frozen state.

Another objective of the present invention is to, by means of the structural combination design, provide a product which enables repetitive use through freezing restoration.

Yet another objective of the present invention is to, by means of the structural combination design, provide a product characterized in convenient storage and application through frozen solidification thereby saving space and transport costs and enabling excellent convenience of the present invention in practical use.

There are a number of existing patents relating to non-alcoholic beverages containing water, carbohydrates and electrolytes for use as a sports refreshment and replenishment, especially for use by participants in endurance sports or activities, but it is my claim that prior invention fails to recognize the benefits of packaging and provision of said products in the frozen state.

Sports drinks provide a valuable means of refreshment and replenishment for sportspeople, especially when sports activities are conducted outdoors and in hot conditions. It is my experiences in such circumstances, that people seek refreshment that is cold, and that the provision of frozen refreshment is not only greatly appreciated but is also superior to that which is liquid.

This invention relates to non-alcoholic beverage products in the frozen state particularly but not exclusively for use as a sports refreshment and electrolyte and carbohydrate replenishment, especially for use by participants in endurance sports or activities.

To achieve the aforementioned purposes, in the structural design of the present invention, they are accomplished mainly by making the heat relieving thirst quencher frozen and solidified for convenient transport in stack, and having it held within a container/bag suitably shaped for storage and hand-carry such that the heat relieving thirst quencher can be accommodated in the container to be properly solidified and shaped. In addition to the heat relieving and thirst quenching functions, the consumers are also allowed to have more fun, further using it for ice covering and swelling subsiding purposes in case of emergent medical care; meanwhile, under unused and molten condition, the heat relieving thirst quencher can be refrozen to its solid state for repetitive use.

### BRIEF DESCRIPTION OF THE DRAWINGS

FIG. 1 shows a structure diagram for a preferred embodiment of the present invention.

FIG. 2 shows a structure diagram for another preferred embodiment of the present invention.

FIG. 3 shows a structure diagram for yet another preferred embodiment of the present invention.

FIG. 4 shows a structure diagram for still another preferred embodiment of the present invention.

FIG. 5 shows a structure diagram for yet still another preferred embodiment of the present invention.

FIG. 6 shows a structure relationship diagram for a preferred embodiment of the present invention.

FIG. 7 shows a preferred application state reference diagram according to the present invention.

FIG. 8 shows another preferred application state reference diagram according to the present invention.

FIG. 9 shows yet another preferred application state reference diagram according to the present invention.

### DETAILED DESCRIPTION OF THE PREFERRED EMBODIMENTS

The structural combination, technical means and achievable effects of the present invention are set forth hereunder through detailed descriptions along with non-restrictive embodiments with reference to accompanied drawings.

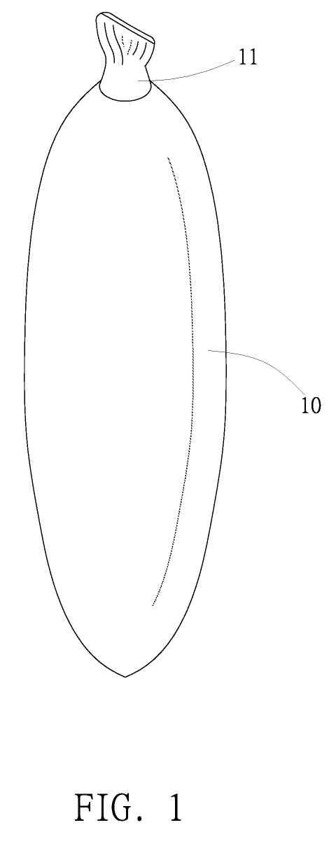

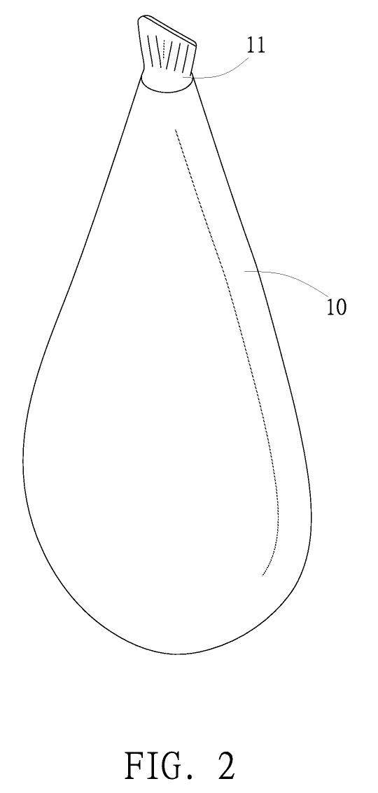

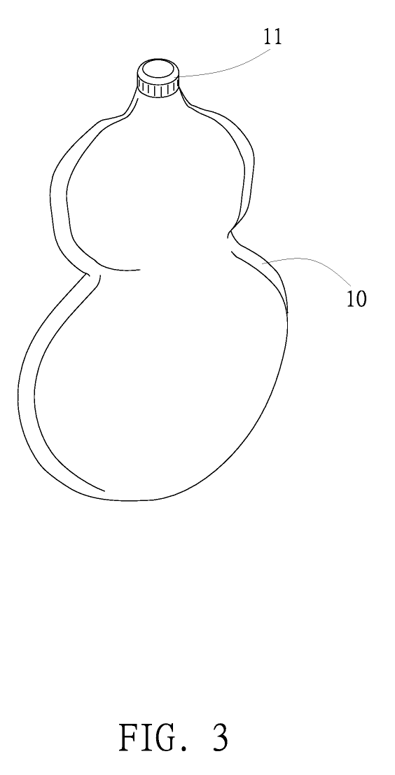

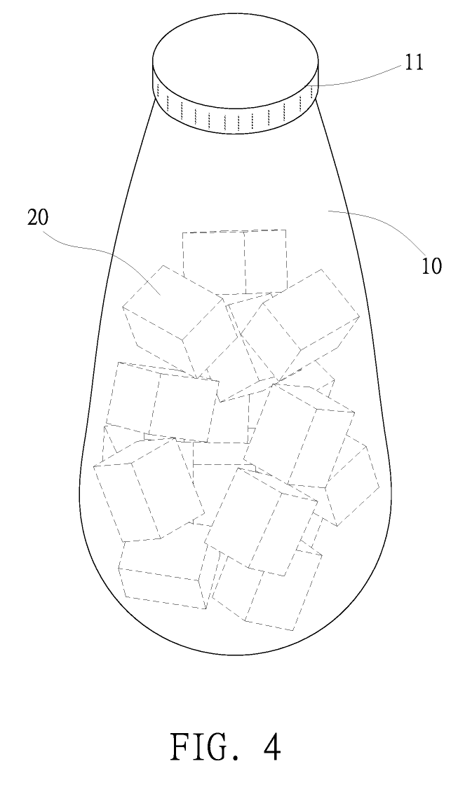

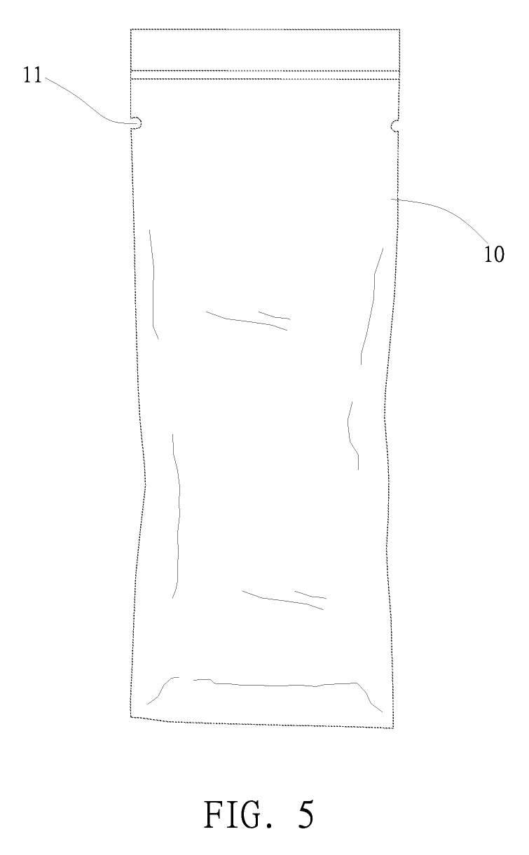

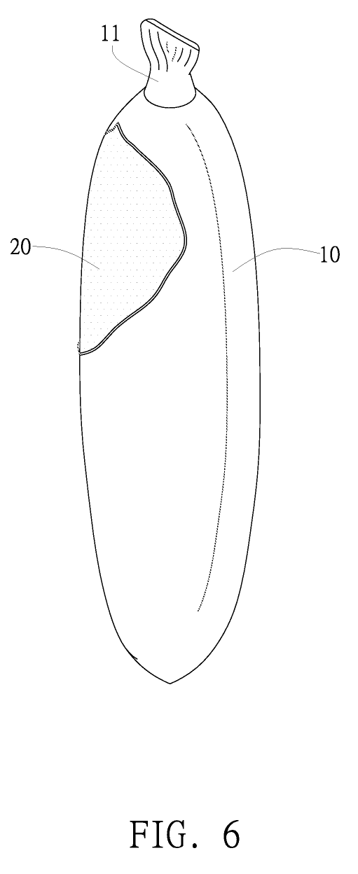

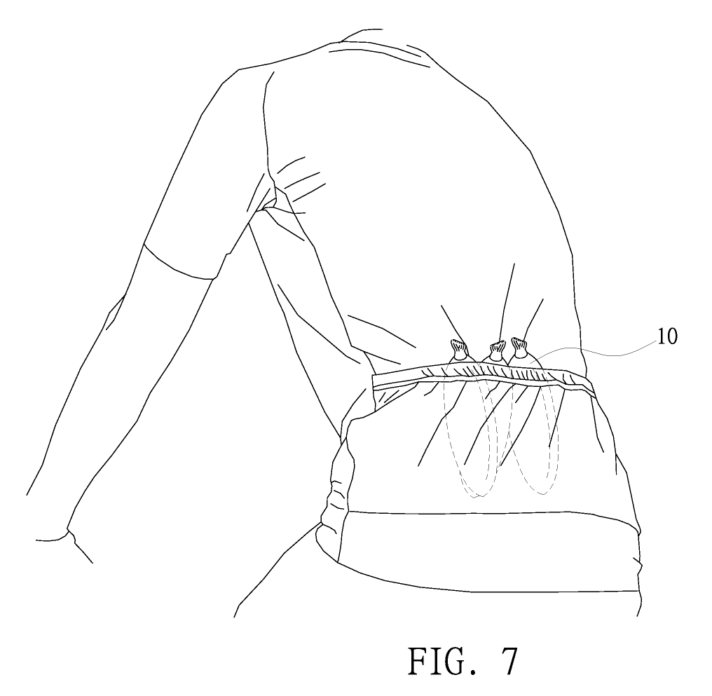

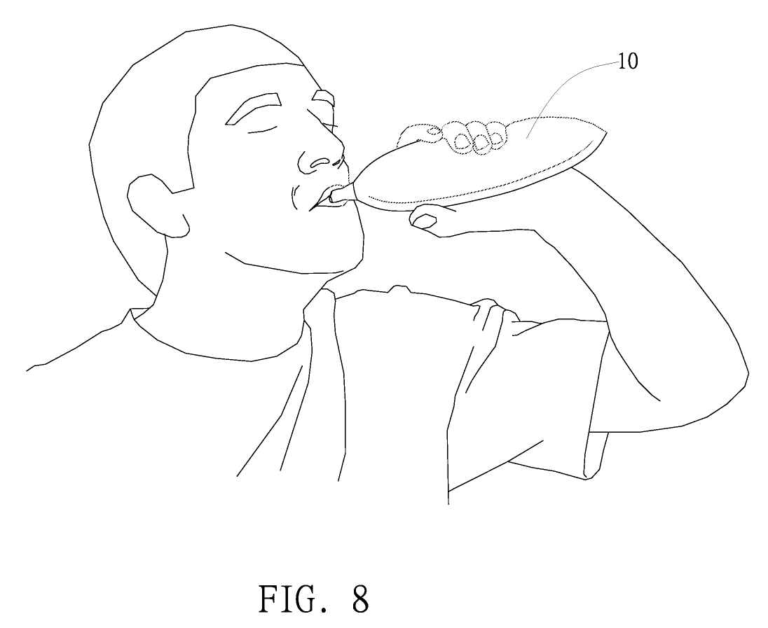

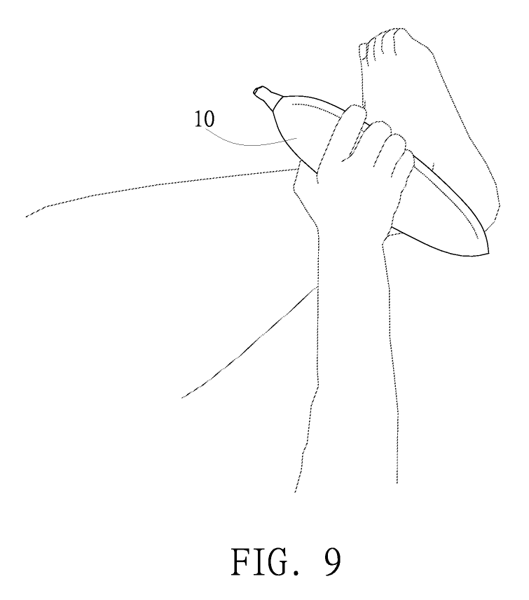

Refer now to the structure diagrams in FIGS. 1-5, the structural relationship diagram in FIG. 6 as well as the application state diagrams in FIGS. 7-9 for illustrations of the preferred embodiments according to the present invention. As shown in these diagrams, the frozen solid state heat relieving thirst quencher according to the present invention essentially, in its structural design, comprises a container/bag (10), wherein the container/bag (10) is preferably sized for convenient hand-carry use; may be differently shaped, e.g. elongated round, oval, pointed round, rectangular, calabash-shaped etc., for various requirements; and can be made of soft or hard materials based on application demands. A filling hole (11) is configured at a predetermined position on the container/bag (10) thereby allowing loading the heat relieving thirst quencher (20) into the container/bag (10). The filling hole (11) may be removably sealed or fixedly sealed. The internal heat relieving thirst quencher (20) may consist of various ingredients such as amino acids, electrolytes, sugar, salt, fruit juice extracts and water. When the heat relieving thirst quencher (20) is filled in the container/bag (10), it forms in a pattern corresponding to the container/bag (10), and after a freezing process, the heat relieving thirst quencher (20) may completely coagulate and solidify such that the heat relieving thirst quencher (20) is packed and protected inside the container/bag (10). As such, the integral functional structure of the frozen solid state heat relieving thirst quencher according to the present invention is constructed.

Through the above-said structural combination design, since that the heat relieving thirst quencher (20) itself includes ingredients like amino acids, electrolytes, sugar, salt, fruit juice extracts, along with its cool and refreshing feature, direct consumption of the heat relieving thirst quencher (20) after or during outdoor sports or activities can effectively reduce discomfort caused by hot summer heat and also allow prompt thirst quenching, stamina restoration and electrolyte replenishment. Also, the size of the container/bag (10) holding the quencher is suitably adapted for hand-carry applications; in this way, compared with conventional bottle/can package for current sport drinks, the present invention allows more economical benefits and occupies less space so as to facilitate convenient transport or carriage with reduced weight loading and garbage amounts after use. Besides, the amount thereof may be appropriately selected for one-time consumption thereby preventing unnecessary wastage. Accordingly, in terms of integral usage and convenience, the present invention excels currently available bottled water or sport drinks and provides a better way of heat relieving, thirst quenching and body energy supplementation for outdoor sports or activities.

Furthermore, since the heat relieving thirst quencher (20) is filled into the container/bag (10) and then frozen into solid state, or alternatively first frozen into bricks and then loaded into the bag, the frozen solid state heat relieving thirst quencher according to the present invention allows not only convenient storage, transport and consumption, but can be directly applied as ice covering for sport injuries like muscle sprain or contusion or else accident wounds such as bee sting or bug biting, thereby promptly offering the best emergent aid and nursing care effects for swelling subsiding and pain relieving without possible time delay problem for acquisition of ice cubes.

Moreover, the heat relieving thirst quencher (20) is loaded and frozen to solid form inside the container/bag (10), so it can be enveloped and protected by the container/bag (10) to maintain its structural completeness such that, even the heat relieving thirst quencher is not consumed but melts to its liquid state, it can be still refrozen to solid state and restored to original form thereby providing practical application and convenience for repetitive reuse.

In other word, through the descriptions set forth as above, it can be appreciated that the frozen solid state heat relieving thirst quencher according to the present invention, in the structure design thereof, can form a special structure pattern by means of either first being frozen into solid state then loading in the container or otherwise using the container suitable for hand-carry to solidify the frozen solid state heat relieving thirst quencher thereby providing the envelop protection, such that the present invention meets the requirements on practical usage and convenience regarding to small volume as well as easy consumption and portability. Also, with its smaller volume, the burden for storage and carriage can be reduced, and the amount can be selected to be sufficient for one-time consumption without causing unnecessary wastage. The present invention can be further applied as an emergent care tool for ice covering and swelling subsiding. If it is molten without consumption, the present invention can be refrozen to its original solid state for repetitive use. Hence, compared with general bottled water or sport drinks, the present invention allows to make the heat relieving thirst quencher frozen into its solid form which is convenient for hand-carry upon performing outdoor sport or activities, and further offers the emergent care function of ice covering and swelling subsiding as well as the repetitive utilization feature, in addition to commonly expected effects like heat relieving, thirst quencher, stamina supplementation etc. Generally speaking, the present invention offers more application values in practice.

In summary, the frozen solid state heat relieving thirst quencher according to the present invention, through its structural combination design, provides a very simple and useful heat relieving tool for outdoor activities or sports which allows to resolve issues and drawbacks found in prior art bottled/canned sport drinks in which it is required to prepare additional ice cubes to achieve the desired cooling and refreshing features thereby significantly saving the package costs of such bottled/canned sport drinks and great wastage amount after consumption. From overall aspects, the present invention enables excellent industrial utilization and practical application and is characterized in its outstandingly and remarkably innovative design, thus herein submitting the present disclosure for patent application in accordance with relevant legal regulations.

What is claimed is:

1. A frozen solid state heat relieving thirst quencher for stamina supplementation, having unlimited solid state profiles and comprising:
a container/bag for holding and refilling the frozen solid state heat relieving thirst quencher, designed to be suitable for hand-carry applications, with a filling hole configured at a preset position thereon for loading the heat relieving thirst quencher; and
the frozen solid state heat relieving thirst quencher, loaded in the container/bag and consisting of at least amino acids, electrolytes, sugar and salt as well as fruit juice extracts.

2. The frozen solid state heat relieving thirst quencher according to claim 1, wherein the container/bag is made of soft materials.

3. The frozen solid state heat relieving thirst quencher according to claim 1, wherein the container/bag is made of hard materials.

4. The frozen solid state heat relieving thirst quencher according to claim 1, wherein the filling hole on the container/bag can sealed or unsealed.

5. The frozen solid state heat relieving thirst quencher according to claim 1, wherein the filling hole on the container/bag is fixedly sealed.

6. The frozen solid state heat relieving thirst quencher according to claim 1, wherein the filling hole on the container/bag is easy-open / pull-up sealed.

7. The frozen solid state heat relieving thirst quencher according to claim 1, wherein the container/bag is elongated round in shape.

8. The frozen solid state heat relieving thirst quencher according to claim 1, wherein the container/bag is oval in shape.

9. The frozen solid state heat relieving thirst quencher according to claim 1, wherein the container/bag is pointed round in shape.

10. The frozen solid state heat relieving thirst quencher according to claim 1, wherein the container/bag is rectangular in shape.

11. The frozen solid state heat relieving thirst quencher according to claim 1, wherein the container/bag is calabash-shaped.
